(19) United States
(12) Patent Application Publication
(10) Pub. No.: US 2007/0046949 A1
(43) Pub. Date: Mar. 1, 2007

(54) Coordinate measuring device

(75) Inventors: Michael Heiden, Woelfersheim (DE); Hans-Arthur Boesser, Breidenbach (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Wetzlar (DE)

(21) Appl. No.: 11/467,410

(22) Filed: Aug. 25, 2006

(30) Foreign Application Priority Data
Aug. 26, 2005 (DE) DE 102005040661.0

(51) Int. Cl. G01B 11/02

(52) U.S. Cl. 356/498

(57) ABSTRACT

The present invention relates to a reference-beam interferometer for determining the position of a traversable stage, wherein an evacuated tube is inserted into the longer of the two interferometer legs. The tube is closed off by windows, which have a negative coefficient of thermal expansion and which can have a coating for reflecting heat radiation. Moreover, thermal compensation plates are inserted into the shorter of the two beam paths.

### RELATED APPLICATIONS

This patent application claims priority of German Patent Application No. 10 2005 040 661.0, filed on Aug. 26, 2005, which is incorporated herein by reference.

### FIELD OF THE INVENTION

The present invention relates to a coordinate measuring device for determining the position of a traversable stage, wherein the position determination is carried out by an interferometer and wherein different path lengths of the measuring and reference beam paths in the interferometer are compensated by a light-transmitting, closed, incompressible body.

### BACKGROUND OF THE INVENTION

Reference-beam interferometers are used for high-precision distance and position measurements and are, for example, an essential component of masks and wafer measuring apparatus for the semiconductor industry. To measure structures of current highly integrated circuits, these devices have a precision in the range of a few nanometers.

In the high-precision interferometric measurement the relative path difference is measured between a measuring mirror on the traversable measuring object in the measuring beam path and a fixed reference mirror in the reference beam path. For this purpose the beams returned on the mirrors overlap, and it is determined by means of interference how the phase of the light changes as the measuring object moves. Herein the wavelength of the light beam is the basis for the measurement, and the relative wavelength difference is indicated using “wavelength” as a unit. The value of the length of a wavelength of a light beam is a function of the refractive index of the medium passed through by the light beam. It varies due to slow or rapid changes in temperature, air pressure and air moisture or due to changes in the air composition.

The requirements on the reproducibility of measurements with generic measuring devices is currently in the range of 5 nm. This is why even the smallest of changes in the above mentioned factors have a critical effect on measuring accuracy. To increase the measuring accuracy it is therefore necessary to reduce the degree to which the above mentioned factors can have an effect. For high-precision distance measurements the measuring device is therefore operated in a climate chamber in which the temperature and the air moisture are held constant. The control accuracy of the temperature and the air moisture has certain technical limits. It is also virtually impossible to create with reasonable efforts a hermetically airtight, in particular pressure-sealed chamber, in particular because it is necessary to exchange the measuring objects easily and rapidly.

U.S. Pat. No. 5,469,260 describes the principle of interferometric position measurement. To increase the measuring accuracy the measuring and reference beam paths are enclosed within tubes open at both ends, into which temperature-stabilized air is blown in a defined way. From DE 196 28 969 C1 a generic reference-beam interferometer for determining the position of a traversable stage is known. In this two-beam interferometer the effect of wavelength changes due to environmental parameters is reduced by introducing a light-transmitting, closed, incompressible body into the longer one of the two interferometer beam paths so that the portions of the reference beam path and the measuring beam path extending outside of the body have the same length at a certain positioning of the traversable measuring mirror. This is how changes in the environmental factors have essentially the same effect on the reference and measuring beam paths and substantially offset each other.

A drawback of the present state of the art lies in the fact that it is no longer able to fulfill the more stringent requirements as to the accuracy of the measurement.

### SUMMARY OF THE INVENTION

It is therefore an object of the present invention to provide a reference-beam interferometer, wherein the effect of environmental parameters on the change in the wavelength of the light beam is further minimized.

This object is fulfilled by an apparatus comprising a measuring mirror mounted on the traversable stage, wherein the measuring mirror has a mirror surface of which is vertical to the traversing direction of the stage, and a fixed reference mirror in parallel orientation having a measuring beam path directed toward the measuring mirror, and a reference beam path directed toward the reference mirror, and a means for determining the position of the traversable stage from the measuring signals generated by the reference-beam interferometer, a light-transmitting, closed, incompressible tube having light-transmitting windows at its ends inserted in each longer one of the two beam paths so that the portions of the beam path extending outside of the tube are equal in length at a predetermined position of the traversable stage, wherein the tube is evacuated.

A further object of the invention is fulfilled by a reference-beam interferometer for determining the position of the traversable stage, comprising a traversable stage and a measuring mirror mounted on the stage, the mirror surface of which is vertical to the traversing direction of the stage, and a fixed reference mirror in parallel orientation having a measuring beam path directed toward the measuring mirror, and a reference beam path directed toward the reference mirror, and a means for determining the position of the stage from the measuring signals generated by the reference-beam interferometer, a light-transmitting, closed, incompressible tube having light-transmitting windows at its ends inserted in each longer one of the two beam paths so that the portions of the beam path extending outside of the tube are equal in length at a predetermined position of the traversable stage, wherein the light-transmitting windows have a negative coefficient of thermal expansion.

An additional object of the invention is fulfilled by a reference-beam interferometer for determining the position of a traversable stage, comprising a traversable stage and a measuring mirror mounted on the stage, the mirror surface of which is vertical to the traversing direction of the stage, and a fixed reference mirror in parallel orientation having a measuring beam path directed toward the measuring mirror, and a reference beam path directed toward the reference mirror, and a means for determining the position of the stage from the measuring signals generated by the reference-beam interferometer, a light-transmitting, closed, incompressible tube having light-transmitting windows at its ends inserted in each longer one of the two beam paths so that the portions of the beam path extending outside of the tube are equal in length at a predetermined position of the traversable stage, wherein the windows have a coating for reflecting heat radiation.

An additional object of the invention is fulfilled by a reference-beam interferometer for determining the position of a traversable stage, comprising a traversable stage and a measuring mirror mounted on the stage, the mirror surface of which is vertical to the traversing direction of the stage, and a fixed reference mirror in parallel orientation having a measuring beam path directed toward the measuring mirror, and a reference beam path directed toward the reference mirror, and a means for determining the position of the stage from the measuring signals generated by the reference-beam interferometer, a light-transmitting, closed, incompressible tube having light-transmitting windows at its ends inserted in each longer one of the two beam paths so that the portions of the beam path extending outside of the tube are equal in length at a predetermined position of the traversable stage, characterized in that one or more thermal compensation plates are inserted in the shorter of the two beam parts having the same dependence overall on the temperature and the optical path as the light-transmitting windows.

Advantageous embodiments of the invention are defined in the dependent claims.

The present invention is based on the idea that the remaining correction error in the distance determination is substantially scaled with the change in wavelength caused by the change in the environmental parameters due to the length difference between the reference beam path and the measuring beam path.

In order to minimize the error in the distance determination due to the change in the wavelength the differences in the path lengths between the reference beam path and the measuring beam path therefore must be kept as small as possible.

According to the present invention the static path length difference due to the positioning of the reference mirror and the measuring mirror in the beam paths is taken up by an evacuated tube provided with windows. In this way it is achieved that the beam extending within the tube is completely shielded from environmental influences. The portion of the beam path within the evacuated tube is a distance of constant path length even with slight changes in temperature and is not affected by errors from the wavelength correction.

Preferably it is provided for the inside pressure of the tube to be monitored by a sensor and for the tube to be connected to a vacuum pump which is driven by the sensor. In this way the quality of the vacuum can be continuously monitored and the vacuum pressure can be readjusted if necessary.

Suitably it is provided that the tube has a coefficient of expansion which is equal to or smaller than that of steel, in particular equal to or smaller than that of glass. This is to ensure that the length of the path of constant path length within the tube remains substantially unaffected by temperature changes.

Advantageously it is provided that the tube has a wall thickness which is greater than 10%, in particular greater than 20%, in particular greater than 50%, in particular greater than 100%, in particular greater than 200%, in particular greater than 500%, in particular greater than 1000% of the inner diameter. With such a construction it is ensured on the one hand that changes in the surrounding pressure, and changes in the surrounding temperature are substantially shielded in their influence on the inside of the tube. On the other hand, due to its increased heat capacity, the tube is less affected by rapid temperature fluctuations. This also applies to the possible expansion of the tube in length.

Advantageously it is provided that the tube has a heat insulation on the outside. This is advantageous in that influences due to changes in temperature are kept away even more effectively from the inside of the tube.

Advantageously it is provided that the tube is of a material having a specific heat conductance which is equal to or smaller than that of aluminum (160 W/mK), in particular equal to or smaller than that of steel (50 W/mK), in particular equal to or smaller than that of glass (1 W/mK). This is to ensure that changes in the surrounding temperature are kept away even more effectively from the inside of the tube.

According to the present invention the originally mentioned object is solved in a generic reference-beam interferometer in that the windows have a negative thermal coefficient of expansion. A corresponding window can comprise, for example, the N-LAK 21 insulating material. The windows having a negative coefficient of thermal expansion in their effect on the beam path offset the expansion of the tube.

Moreover, the originally mentioned object is solved according to the present invention in a generic reference-beam interferometer in that the windows have a coating for reflecting heat radiation. As a result it is avoided that heat radiation enters into the interior of the tube and exposes it to the effects of temperature fluctuations which can lead to wavelength variations.

According to the present invention the originally mentioned object is further solved in a generic reference-beam interferometer in that one or more thermal compensation plates are inserted in the shorter beam path with a comparable dependency on the temperature and the optical path overall to those of the windows of the tube. With this arrangement the temperature dependency of the path length variations between the two interferometer beams is compensated by the tube windows.

Advantageously the one or more compensation plates are of the same material as the windows and have the same thickness overall as the two windows taken together. By making the compensation plates identical in their form and number to the tube windows the effect of the tube windows on the temperature induced path length variations is almost entirely eliminated.

Particularly advantageous is that the one or more compensation plates have an overall thickness which is slightly less than the two windows taken together. In particular they are up to 1/1000, in particular by up to 1/500, in particular by up to 1/250 of the length of the tube thinner than the two windows taken together. With this construction the temperature dependency of the length of the tube is essentially compensated for.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The present invention will be described in the following with reference to schematic representations of an exemplary embodiment in more detail. The same reference numerals indicate the same elements throughout the figures, in which:

FIG. 1 shows an interferometer with beam path compensation,

FIG. 2 shows a tube according to the present invention for beam path compensation.

### DETAILED DESCRIPTION OF THE PREFERRED EMBODIMENTS

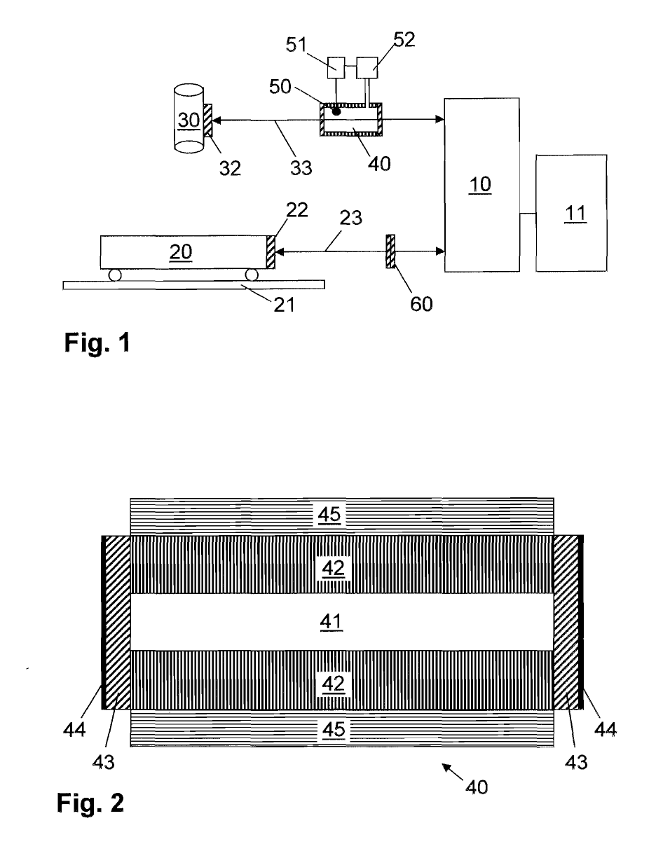

FIG. 1 shows a coordinate measuring device with a reference-beam interferometer 10 together with its reference beam path 33 and its measuring beam path 23. Measuring beam 23 impinges on measuring mirror 22, which is attached on traversable stage 20. Stage 20 is traversable with respect to a fixed base 21 and carries the measuring object (not shown). Reference beam 33 impinges on reference mirror 32, which is attached on the fixed lens assembly 30. Lens assembly 30 is focused on a measuring point on the measuring object placed on the traversable stage. In the measuring process the measuring object on the traversable stage is sufficiently moved by the latter so that the lens assembly focuses on another measuring point. The distance between the two measuring points is measured by the reference-beam interferometer as a distance variation of the traversable stage with respect to the lens assembly. Reference-beam interferometer 10 is coupled to a position determining means 11 for evaluating the signals of the interferometer. In the illustrated case reference beam 33 is longer than measuring beam 23. The reference beam would therefore be affected more strongly by variations in the wavelength than the measuring beam. In order to compensate for this stronger effect, a beam path compensation is inserted in reference beam 33 in the form of tube 40. As a result the portions of reference beam 33 extending outside of tube 40 have about the same length as measuring beam 23 for an assumed central position of traversable stage 20. Tube 40 is closed off by means of light-transmitting windows, and evacuated. The vacuum within the tube is held constant by means of a pressure sensor 50 within the tube, a control unit 51 and a vacuum pump 52. Compensation plates 60 are inserted in measuring beam 23, which are essentially identical to the windows closing off the tube. The temperature influence that the tube windows have on the path length variation in the reference beam are thus compensated for.

FIG. 2 shows a cross-sectional view of tube 40. The tube consists of a tube wall 42 and windows 43 for enclosing vacuum 41. The windows are provided on their outside with a coating 44 insulating against heat radiation. They can be additionally provided with an anti-reflection coating (not shown) on the inside and outside for the measuring beam. Tube 42 is surrounded by heat insulation 45.

While this invention has been particularly shown and described with references to preferred embodiments thereof, it will be understood by those skilled in the art that various changes in form and details may be made therein without departing from the scope of the invention encompassed by the appended claims.

What is claimed is:

1. A reference-beam interferometer for determining the position of a traversable stage, comprising a measuring mirror mounted on the traversable stage, wherein the measuring mirror has a mirror surface of which is vertical to the traversing direction of the stage, and a fixed reference mirror in parallel orientation having a measuring beam path directed toward the measuring mirror, and a reference beam path directed toward the reference mirror, and a means for determining the position of the traversable stage from the measuring signals generated by the reference-beam interferometer, a light-transmitting, closed, incompressible tube having light-transmitting windows at its ends inserted in each longer one of the two beam paths so that the portions of the beam path extending outside of the tube are equal in length at a predetermined position of the traversable stage, wherein the tube is evacuated.

2. The apparatus according to claim 1, wherein the internal pressure of the tube is monitored by a sensor and the tube is connected to a vacuum pump driven by the sensor.

3. The apparatus according to claim 1, wherein the tube has a coefficient of expansion which is smaller than that of steel, in particular smaller than that of glass.

4. The apparatus according to claim 1, wherein the tube has a wall thickness of greater than 10%, in particular greater than 20%, in particular greater than 50%, in particular greater than 100%, in particular greater than 200%, in particular greater than 500%, in particular greater than 1000% of the inner diameter.

5. The apparatus according to claim 1, wherein the tube has a heat insulation toward the outside.

6. The apparatus according to claim 1, wherein the tube is of a material having a specific heat conductance which is equal to or smaller than 160 W/mK (aluminum), in particular equal to or smaller than 50 W/mK (steel), in particular equal to or smaller than 1 W/mK (glass).

7. The apparatus according to claim 1, wherein the light-transmitting windows have a negative coefficient of thermal expansion.

8. The apparatus according to claim 7, wherein the light-transmitting windows have a coating for reflecting heat radiation.

9. The apparatus according to claim 1, wherein one or more thermal compensation plates are inserted in the shorter beam path which have substantially comparable dependence on temperature and optical path overall to that of the light-transmitting windows.

10. The apparatus according to claim 1, wherein the one or more compensation plates are of the same material as the light-transmitting windows and have a thickness overall comparable to that of the two light-transmitting windows taken together.

11. The apparatus according to claim 1, wherein the one or more compensation plates are slightly thinner overall than the two light-transmitting windows taken together, in particular by up to 1/1000 of the length of the tube, in particular by up to 1/500 of the length of the tube, in particular by up to 1/250 of the length of the tube.

12. A reference-beam interferometer for determining the position of the traversable stage, comprising a traversable stage and a measuring mirror mounted on the stage, the mirror surface of which is vertical to the traversing direction of the stage, and a fixed reference mirror in parallel orientation having a measuring beam path directed toward the measuring mirror, and a reference beam path directed toward the reference mirror, and a means for determining the position of the stage from the measuring signals generated by the reference-beam interferometer, a light-transmitting, closed, incompressible tube having light-transmitting windows at its ends inserted in each longer one of the two beam paths so that the portions of the beam path extending outside of the tube are equal in length at a predetermined position of the traversable stage, wherein the light-transmitting windows have a negative coefficient of thermal expansion.

13. A reference-beam interferometer for determining the position of a traversable stage, comprising a traversable stage and a measuring mirror mounted on the stage, the mirror surface of which is vertical to the traversing direction of the stage, and a fixed reference mirror in parallel orientation having a measuring beam path directed toward the measuring mirror, and a reference beam path directed toward the reference mirror, and a means for determining the position of the stage from the measuring signals generated by the reference-beam interferometer, a light-transmitting, closed, incompressible tube having light-transmitting windows at its ends inserted in each longer one of the two beam paths so that the portions of the beam path extending outside of the tube are equal in length at a predetermined position of the traversable stage, wherein the windows have a coating for reflecting heat radiation.

14. A reference-beam interferometer for determining the position of a traversable stage, comprising a traversable stage and a measuring mirror mounted on the stage, the mirror surface of which is vertical to the traversing direction of the stage, and a fixed reference mirror in parallel orientation having a measuring beam path directed toward the measuring mirror, and a reference beam path directed toward the reference mirror, and a means for determining the position of the stage from the measuring signals generated by the reference-beam interferometer, a light-transmitting, closed, incompressible tube having light-transmitting windows at its ends inserted in each longer one of the two beam paths so that the portions of the beam path extending outside of the tube are equal in length at a predetermined position of the traversable stage, characterized in that one or more thermal compensation plates are inserted in the shorter of the two beam parts having the same dependence overall on the temperature and the optical path as the light-transmitting windows.

15. The apparatus according to claim 14, wherein the one or more compensation plates are of the same material as the light-transmitting windows and have a thickness overall comparable to that of the two light-transmitting windows taken together.

16. The apparatus according to claim 15, wherein the one or more compensation plates are slightly thinner overall than the two light-transmitting windows taken together, in particular by up to 1/1000 of the length of the tube, in particular by up to 1/500 of the length of the tube, in particular by up to 1/250 of the length of the tube.
